(19) United States
(12) Patent Application Publication
(10) Pub. No.: US 2023/0116470 A1
(43) Pub. Date: Apr. 13, 2023

(54) ANALYZER WITH AUTO-LOADER

(71) Applicant: Alcor Scientific, Inc., Smithfield, RI (US)

(72) Inventors: Peter J. Sacchetti, North Falmouth, MA (US); Francesco A. Frappa, Udine (IT); Carlo Ruggeri, Lincoln, RI (US)

(21) Appl. No.: 17/906,189

(22) PCT Filed: Jan. 26, 2022
(86) PCT No.: PCT/US2022/013931

§ 371 Date: Sep. 12, 2022

Related U.S. Application Data
(60) Provisional application No. 63/142,174, filed on Jan. 27, 2021.

(51) Int. Cl. G01N 35/04; G01N 35/02; G01N 35/00

(52) U.S. Cl. CPC G01N 35/04; G01N 35/026; G01N 35/00732; G01N 2035/0418

(57) ABSTRACT

An analyzer includes an analytical unit, the analytical unit including at least a mixing wheel, a piercing system, a reading cell and a hydraulic system, a rack holding system holding homogeneous racks, each of the homogeneous racks including sample tubes, a robotic arm to pick up any one of homogeneous racks and load sample tubes from it into the mixing wheel, and a system handler processor, the analytical unit, the rack holding system and the robotic arm communicatively linked by the system handler processor.

### CROSS REFERENCE TO RELATED APPLICATIONS

This application claims benefit from U.S. Provisional Patent Application Ser. No. 63/142,174, filed Jan. 27, 2021, which is incorporated by reference in its entirety.

### STATEMENT REGARDING GOVERNMENT INTEREST

None.

### BACKGROUND OF THE INVENTION

The invention generally relates to a medical analyzer, and in particular to an analyzer with auto-loader.

Medical analyzers are used to measure various functions of a patient. For example, an erythrocyte sedimentation rate (ESR) analyzer measures an ESR or sed rate, which is a clinical lab test that measures the rate at which red blood cells in whole blood descend into a standardized tube, reported as mm per hour. This test is used to measure inflammation because red blood cells of patients with inflammation settle quicker than in normal patients. Thus, a high ESR can be indicative of elevated inflammation, though other conditions such as anemia, renal failure, and obesity can increase ESR rate as well.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features an analyzer including an analytical unit, the analytical unit including at least a mixing wheel, a piercing system, a reading cell and a hydraulic system, a rack holding system holding homogeneous racks, each of the homogeneous racks including sample tubes, a robotic arm to pick up any one of homogeneous racks and load sample tubes from it into the mixing wheel, and a system handler processor, the analytical unit, the rack holding system and the robotic arm communicatively linked by the system handler processor.

In another aspect, the invention features a method including providing an analyzer, the analyzer including an analytical unit, the analytical unit including at least a mixing wheel, a piercing system, a reading cell and a hydraulic system, a rack holding system holding homogeneous racks, each of the homogeneous racks including sample tubes, a robotic arm to pick up any one of the homogeneous racks and load sample tubes from it into the mixing wheel, and a system handler processor, the analytical unit, the rack holding system and the robotic arm communicatively linked by the system handler processor, selecting a rack of sample tubes; picking up each one of the sample tubes in the selected rack with a robotic arm and placing the picked sample tube into a mixing wheel, performing an analysis on the picked sample tube, and returning the picked sample tube to the selected rack.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram.

FIG. 2 is an illustration of an exemplary system.

FIG. 3 is an illustration of an exemplary fully loaded system.

FIG. 4 is an illustration of an exemplary analytical unit.

FIG. 5 is an illustration of an exemplary rack holding system.

FIG. 6 is an illustration of an exemplary robotic arm.

FIG. 7 is another illustration of an exemplary robotic arm.

FIG. 8 is an illustration of an exemplary loading rack.

FIG. 9 is an illustration of an exemplary piercing system reading cell.

FIG. 10 is an illustration of an exemplary mixing wheel.

FIG. 11 is an illustration of an exemplary arm tube mixing wheel interaction.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The present invention will now be described with reference to ESR testing. However, techniques described herein are not limited to ESR testing and may be adapted to a variety of test systems.

Erythrocyte sedimentation rate (ESR) testing is typically performed using analyzers. These analyzers speed run time, while enhancing safety and accuracy. One standard technique for ESR testing is called the Westergren Method in which whole blood is mixed with sodium citrate or ethylenediaminetetraacetic acid (EDTA) as an anticoagulant and then added to a standardized calibrated tube, which is allowed to sit for one hour. Sedimentation rate is measured by recording the number of millimeters between the top of the sedimented red blood cells and the zero mark of the tube. Many analyzers operate using the Westergren Method, though instruments employing alternative methods have begun to emerge. Features important in an ESR analyzer include, for example, its capacity, run time, throughput, dimensions, sample tracking features and so forth. Commercially available ESR analyzers include, for example, the iSED® ESR Analyzer and the miniiSED® ESR Analyzer, both from Alcor Scientific Inc.

It should be noted that the system and method described herein does not measure according to the Westergren method. Instead, system and method described herein measures aggregation optically and then converts the obtained data to an equivalent Westergren result expressed in mm/h.

There is a portion of the ESR analyzer market that uses racks as media to transport sample tubes. The system of the present invention is capable of loading a number of tubes contained into racks already in use on analyzers rather than loading tubes one by one into a mixing wheel.

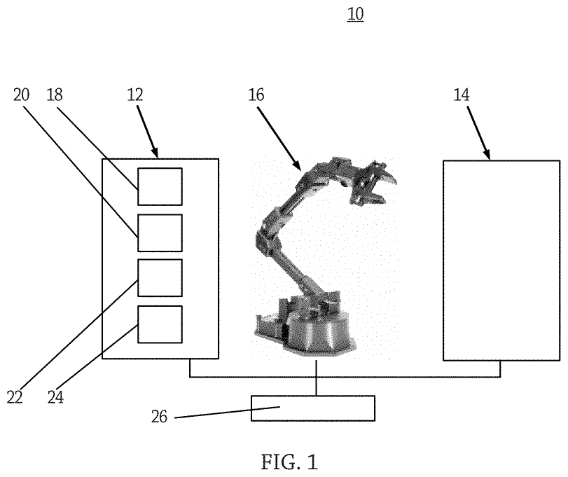

As shown in FIG. 1, an exemplary ESR analyzer 10 includes an analytical unit 12, a rack holding system 14 and a robotic arm 16. The rack holding system 14 can hold any number of homogeneous racks. For example, the rack holding system 14 may contain one rack of ten samples tubes, each of which may be pierced. The robotic arm 16 picks up a sample tube from any rack position in the rack and loads it into a mixing wheel 18 of the analytical unit 12. After insertion, each rack is locked in position until all its tubes have been processed. After completion, the rack is released for manual extraction. A rack is considered completely processed when all its contained tubes are evaluated for measurement and re-positioned on its original pickup location.

Potentially, not all the tubes inside the rack require ESR analysis. Therefore, the ESR Analyzer 10 extracts a tube from its rack location, identifies the extracted tube using, for example, barcode label detection, executes a request to a Laboratory Integration System (LIS) and, in case ESR analysis is not required, immediately repositions the tube on its original position. If ESR analysis is required, the sample tube is placed on the mixing wheel, where the measurement process starts. This step is executed for all samples inserted into the ESR Analyzer 10 with coordination with the mixing wheel. After a tube is measured successfully by the analytical unit 12, which includes the mixing wheel 18, a piercing system 20, a reading cell 22 and a hydraulic system 24, the mixing wheel 18 positions the tube ready for extraction on a loading/downloading position, to enable the robotic arm 16 to extract it and position it back on its position of origin inside the rack in the rack holding system 14.

The ESR analyzer 10 also includes system handler processor 26. The analytical unit 12, the rack holding system 14 and the robotic arm 16 are all in communication to each other via the system handler processor 26.

The rack holding system 14 is interchangeable based on rack type, such Sysmex®, Beckman Coulter®, and so forth. The rack holding system 14 may include one or more of the following features. The rack holding system 14 may be able to receive more than one rack, lock the rack in place via, for example, a solenoid latch, notify a user via visual indication of a rack status, notify the system which rack is meant to receive to adjust pick and place coordinates, and able to release the rack when completed.

The robotic arm 16 is able to reach every rack location, grip each sample tube inside the rack and extract sample tubes from the rack. The robotic arm 16 is able to detect a sample tube ID via, for example, barcode reader, able to position the extracted tube into the mixing wheel and able to re-position the measured tube from the mixing wheel to the original rack position.

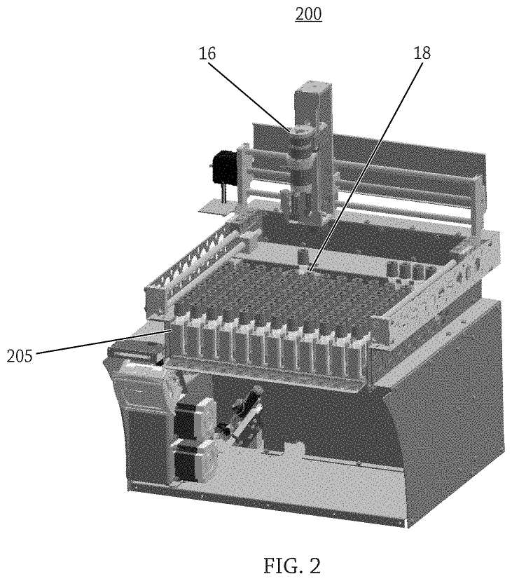

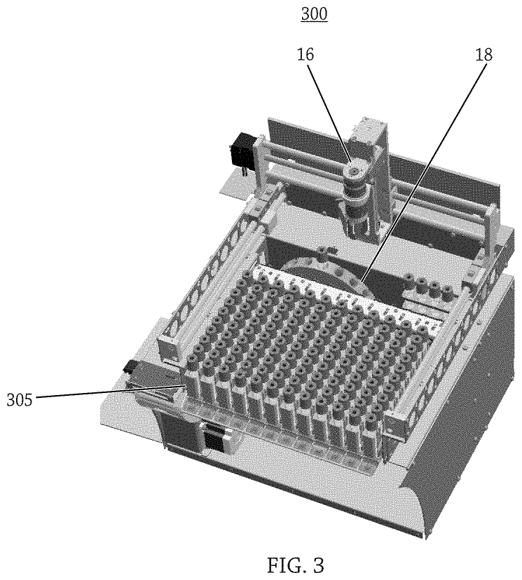

In FIGS. 2 and 3, exemplary systems 200, 300, respectively, are illustrated. In each case, racks 205, 305, respectively, are fully loaded.

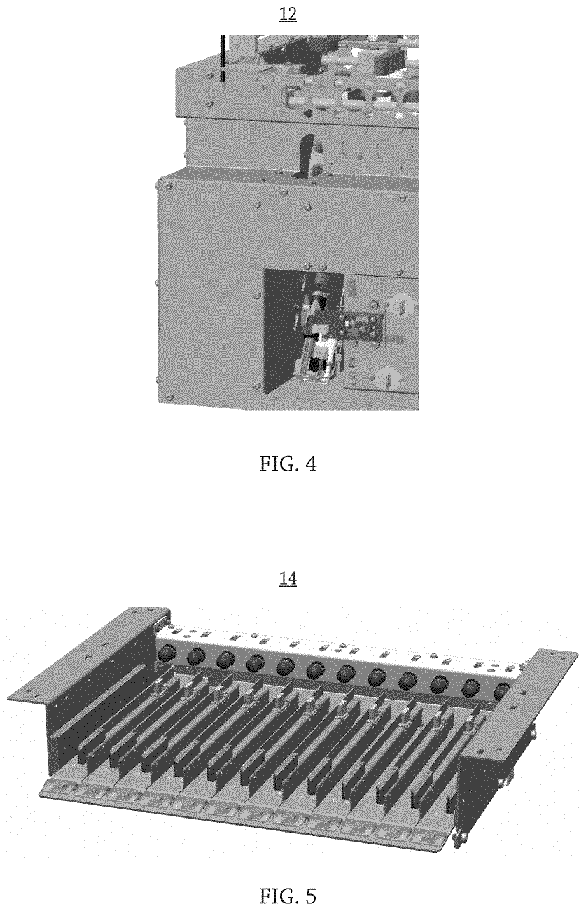

In FIG. 4, the analytical unit 12 is illustrated. In one example, the analytical unit measures sedimentation rate Via evaluation of red blood cell aggregation by digitizing and recording the optical variation inside the reading cell over time and mathematically process and convert these optical values to a value comparable with Westergren method and expressed in millimeters per hour (mm/h).

In FIG. 5, the rack holding system 14 is illustrated. As described above, the rack holding system 14 can hold any number of homogeneous racks.

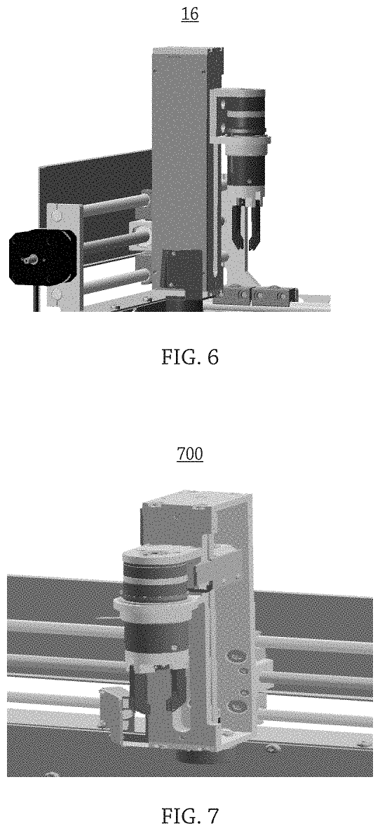

In FIG. 6, the robotic arm 16 is illustrated. As described above, The robotic arm 16 picks up a sample tube from any rack position in the rack and loads it into the mixing wheel 18 of the analytical unit 12.

In FIG. 7, is another exemplary robotic arm 700 is illustrated.

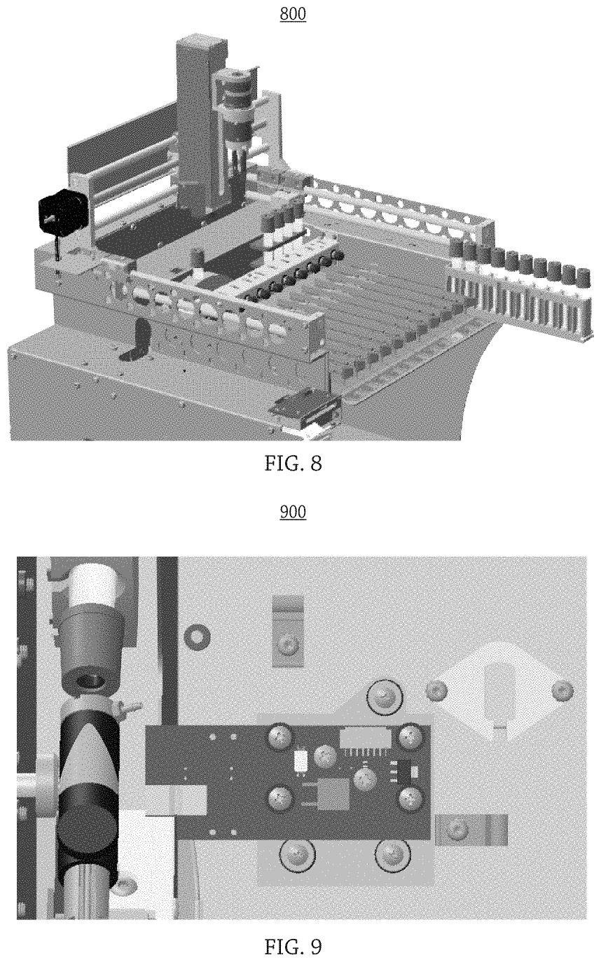

In FIG. 8, an exemplary loading rack 800 is illustrated.

In FIG. 9, an exemplary piercing system reading cell 900 is illustrated.

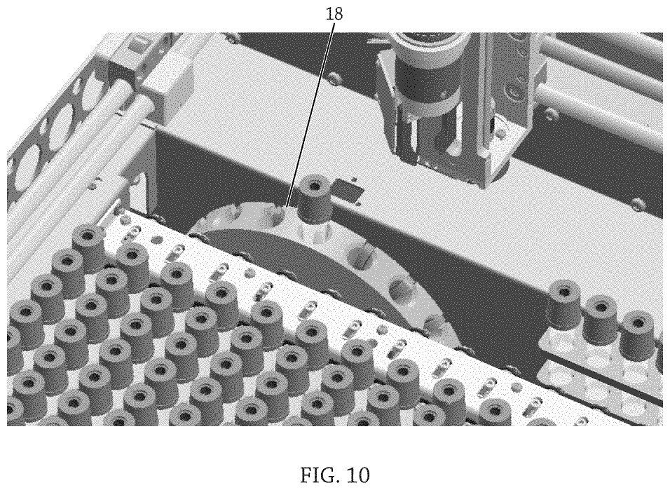

In FIG. 10 the mixing wheel 18 is illustrated.

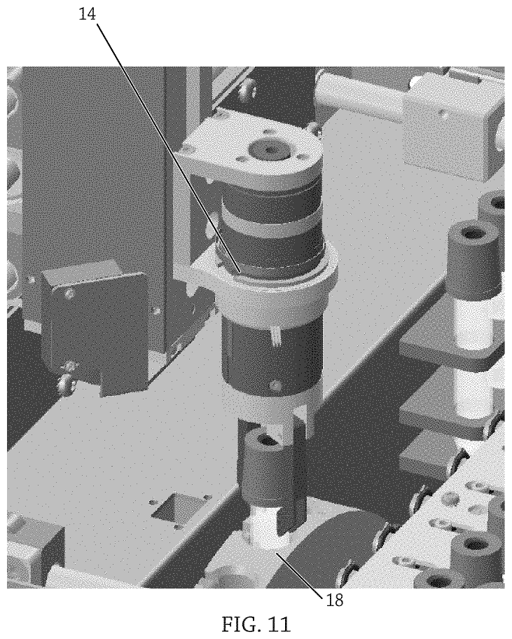

In FIG. 11, an exemplary arm 14/tube mixing wheel 18 interaction is illustrated.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

1. An analyzer comprising:
an analytical unit, the analytical unit including at least a mixing wheel, a piercing system, a reading cell and a hydraulic system;
a rack holding system holding a plurality of homogeneous racks, each of the plurality of homogeneous racks comprising a plurality of sample tubes;
a robotic arm to pick up any one of the plurality of homogeneous racks and load sample tubes from it into the mixing wheel; and
a system handler processor, the analytical unit, the rack holding system and the robotic arm communicatively linked by the system handler processor.

2. The analyzer of claim 1 wherein the analytical unit further includes a reader configured to read a code or identification located on each of the plurality of sample tubes.

3. The analyzer of claim 2 wherein the rack holding system is interchangeable based on a rack type.

4. The analyzer of claim 3 wherein the rack type is an interchangeable rack type.

5. The analyzer of claim 3 wherein the robotic arm reaches every rack location in the rack holding system.

6. The analyzer of claim 3 wherein the robotic arm grips each sample tube inside a rack and extracts sample tubes from the rack.

7. The analyzer of claim 3 wherein the robotic arm detects a sample tube identification.

8. The analyzer of claim 3 wherein the robotic arm positions an extracted tube into the mixing wheel and re-positions a measured tube from the mixing wheel to an original rack position.

9. The analyzer of claim 1 wherein the system handler processor is communicatively linked to a Laboratory Integration System (LIS).

10. The analyzer of claim 9 wherein the Laboratory Integration System is configured to provide information on whether a particular sample tube requires analysis.

11. A method comprising:
providing an analyzer, the analyzer comprising:
an analytical unit, the analytical unit including at least a mixing wheel, a piercing system, a reading cell and a hydraulic system;
a rack holding system holding a plurality of homogeneous racks, each of the plurality of homogeneous racks comprising a plurality of sample tubes;
a robotic arm to pick up any one of the plurality of homogeneous racks and load sample tubes from it into the mixing wheel; and
a system handler processor, the analytical unit, the rack holding system and the robotic arm communicatively linked by the system handler processor;
selecting a rack of sample tubes;
picking up each one of the sample tubes in the selected rack with the robotic arm and placing the picked sample tube into a mixing wheel;
performing an analysis on the picked sample tube; and
returning the picked sample tube to the selected rack.

12. The method of claim 11 wherein performing an analysis comprises:
reading an identification on the picked sample tube;
sending the identification to a Laboratory Integration System (LIS).

13. The method of claim 12 wherein the Laboratory Integration System is configured to provide information on whether an analysis is to be performed on the picked sample tube.

14. The method of claim 12 wherein the identification is a barcode.

15. The method of claim 12 wherein reading the identification is performed by the analytical unit.
